(19) United States
(12) Patent Application Publication
(10) Pub. No.: US 2007/0004613 A1
(43) Pub. Date: Jan. 4, 2007

(54) Liquid bleaching composition

(76) Inventors: Maartje Ouwendijk-vrijenhoek, VLAARDINGEN (NL); Derdiyok Sonmezer, Vlaardingen (NL); Simon Marinus Veerman, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/559,963

(22) PCT Filed: May 21, 2004
(86) PCT No.: PCT/EP04/05499

§ 371 Date: May 5, 2006

(30) Foreign Application Priority Data
Jun. 9, 2003 (GB) 0313246.1
Jan. 28, 2004 (GB) 0401810.7

(51) Int. Cl. C11D 3/00

(52) U.S. Cl. 510/376

(57) ABSTRACT

The present invention concerns the preservation of a catalyst in a bleaching composition whilst facilitating activation of the catalyst. The bleaching composition is substantially devoid of a peroxygen bleach or a peroxy-based or peroxyl-generating bleach system.

### FIELD OF INVENTION

The present invention provides a liquid bleaching composition.

### BACKGROUND OF THE INVENTION

The use of bleaching catalysts for stain removal has been developed over recent years. The recent discovery that some catalysts are capable of bleaching effectively in the absence of an added peroxyl source has recently become the focus of some interest, for example: WO9965905; WO0012667; WO0012808; WO0029537, and, WO0060045.

The shelf life of a product may be regarded as the period of time over which the product may be stored whilst retaining its required quality. A satisfactory shelf life is in many instances a crucial factor for the success of a commercial product. A product with a short shelf life generally dictates that the product is made in small batches and is rapidly sold to the consumer. It is also a concern to the owners of a brand with a short shelf life that the consumer uses the product within the shelf life otherwise the consumer may be inclined to change to a similar product of another brand. In contrast a similar product with a long shelf life may be made in larger batches, held as stock for a longer period of time and the period of time that a consumer stores the product is not of a great concern to the owners of a particular brand. Despite the shelf life being an important consideration the product must also be active during use.

It is an object of the present invention to provide an air bleaching composition that has improved storage properties whilst being active in use.

### SUMMARY OF INVENTION

We have found that the storage pH conditions required for longevity of a liquid bleaching composition are in conflict with the pH required for providing good bleaching activity.

The present invention provides a liquid bleaching composition having a pH between 6 and 7 comprising:

(a) an organic substance which forms a complex with a transition metal for bleaching a substrate with atmospheric oxygen, the bleaching composition upon addition to an aqueous medium providing an aqueous bleaching medium substantially devoid of a peroxygen bleach or a peroxy-based or peroxyl-generating bleach system;

(b) a pH changing means; and,

(c) the balance carriers and adjunct ingredients to 100 wt/wt % of the total bleaching composition, wherein upon dilution of the liquid bleaching composition with water the pH of the liquid bleaching composition enters the range pH 7.5 to pH 9.0.

The present invention also provides a method of bleaching a textile comprising the steps of:

(i) diluting from 0.5 to 20 g of a concentrated liquid bleaching composition with 1 litre of water, the concentrated liquid bleaching composition having a pH in the range 6 to 7, the liquid bleaching comprising an organic substance which forms a complex with a transition metal for bleaching a substrate with atmospheric oxygen, the bleaching composition upon addition to an aqueous medium providing an aqueous bleaching medium substantially devoid of a peroxygen bleach or a peroxy-based or peroxyl-generating bleach, the dilution providing an aqueous liquid bleaching composition having a pH in the range from 7.5 to pH 9.0;
(ii) treating a textile with the aqueous liquid bleaching composition; and,
(iii) rinsing the textile with water; and,
(iv) drying the textile.

The term “substantially devoid of a peroxygen bleach or a peroxy-based or peroxyl-generating bleach system” should be construed within spirit of the invention. It is preferred that the composition has as low a content of peroxyl species present as possible. It is preferred that the bleaching formulation contains less that 1% wt/wt total concentration of peracid or hydrogen peroxide or source thereof, preferably the bleaching formulation contains less that 0.3% wt/wt total concentration of peracid or hydrogen peroxide or source thereof, most preferably the bleaching composition is devoid of peracid or hydrogen peroxide or source thereof. In addition, it is preferred that the presence of alkyl hydroperoxides is kept to a minimum in a bleaching composition comprising the ligand or complex of the present invention.

The present invention also extends to a commercial package together with instructions for its use.

### DETAILED DESCRIPTION OF THE INVENTION

The Bleach Catalyst

Recently we have found that oily stains are bleached in the presence of selected transition metal catalysts in the absence of an added peroxyl source. The bleaching of an oily stain in the absence of an added peroxyl source has been attributed to oxygen derived from the air. Whilst it is true that bleaching is effected by oxygen sourced from the air the route in which oxygen plays a part is becoming understood. In this regard, the term “air bleaching” is used.

We have concluded from our research that bleaching of a chromophore in an oily stain is effected by products formed by adventitious oxidation of components in the oily stain. These products, alkyl hydroperoxides, are generated naturally by autoxidation of the oily stain and the alkyl hydroperoxides together with a transition metal catalyst serve to bleach chromophores in the oily stain. Alkyl hydroperoxides (ROOH) are generally less reactive that other peroxy species, for example, peracids (RC(O)OOH), hydrogen peroxide (H2O2), percarbonates and perborates. In this regard, the phrase “for bleaching a substrate with atmospheric oxygen” is synonymous with “for bleaching a substrate via atmospheric oxygen” because it is the oxygen in the air that provides the bleaching species used by catalyst to bleach the substrate stain.

The bleach catalyst per se may be selected from a wide range of transition metal complexes of organic molecules (ligands). In typical washing compositions the level of the organic substance is such that the in-use level is from 0.05 μM to 50 mM, with preferred in-use levels for domestic laundry operations falling in the range 1 to 100 μM. Higher levels may be desired and applied in industrial textile bleaching processes. A mixture of different catalysts may be employed in the bleaching composition.

Suitable organic molecules (ligands) for forming complexes and complexes thereof are found, for example in: GB 9906474.3; GB 9907714.1; GB 98309168.7, GB 98309169.5; GB 9027415.0 and GB 9907713.3; DE 19755493; EP 999050; WO9534628; EP-A-458379; EP 0909809; U.S. Pat. No. 4,728,455; WO9839098; WO9839406, WO9748787, WO0029537; WO0052124, and WO0060045 the complexes and organic molecule (ligand) precursors of which are herein incorporated by reference. An example of a preferred catalyst is a transition metal complex of MeN4Py ligand (N,N-bis(pyridin-2-yl-methyl)-1,1-bis(pyridin-2-yl)-1-aminoethane).

The ligand forms a complex with one or more transition metals, in the latter case for example as a dinuclear complex. Suitable transition metals include for example: manganese in oxidation states II-V, iron II-V, copper I-III, cobalt I-III, titanium II-IV, tungsten IV-VI, vanadium II-V and molybdenum II-VI.

An example of a preferred catalyst is a monomer ligand or transition metal catalyst thereof of a ligand having the formula (I): 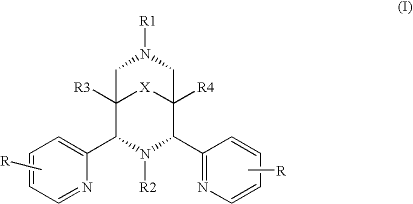
wherein each R is independently selected from: hydrogen, F, Cl, Br, hydroxyl, C1-C4-alkylO—, —NH—CO—H, —NH—CO—C1-C4-alkyl, —NH2, —NH—C1-C4-alkyl, and C1-C4-alkyl; R1 and R2 are independently selected from:

C1-C4-alkyl,

C6-C10-aryl, and,

a group containing a heteroatom capable of coordinating to a transition metal, wherein at least one of R1 and R2 is the group containing the heteroatom;

R3 and R4 are independently selected from hydrogen, C1-C8 alkyl, C1-C8-alkyl-O—C1-C8-alkyl, C1-C8-alkyl-O—C6-C10-aryl, C6-C10-aryl, C1-C8-hydroxyalkyl, and —(CH2)ₙC(O)OR5 wherein R5 is independently selected from: hydrogen, C1-C4-alkyl, n is from 0 to 4, and mixtures thereof; and, X is selected from C═O, —[C(R6)₂]_{y}- wherein Y is from 0 to 3 each R6 is independently selected from hydrogen, hydroxyl, C1-C4-alkoxy and C1-C4-alkyl.

With regard to the above formula (I) it is also particularly preferred that R1 and R2 may also be independently selected from: C1 to C22-optionally substituted alkyl, and an optionally substituted tertiary amine of the form —C2-C4-alkyl-NR7R8, in which R7 and R8 are independently selected from the group consisting of straight chain, branched or cyclo C1-C12 alkyl, benzyl, the —C2-C4-alkyl- of the —C2-C4-alkyl-NR7R8 may be substituted by 1 to 4 C1-C2-alkyl, or may form part of a C3 to C6 alkyl ring, and in which R7 and R8 may together form a saturated ring containing one or more other heteroatoms.

Another preferred class of ligands are macropolycyclic rigid ligands of the formula: 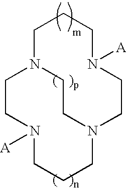
wherein m and n are 0 or integers from 1 to 2, p is an integer from 1 to 6, preferably m and n are both 0 or both 1 (preferably both 1), or m is 0 and n is at least 1; and p is 1; and A is a nonhydrogen moiety preferably having no aromatic content; more particularly each A can vary independently and is preferably selected from methyl, ethyl, propyl, isopropyl, butyl, isobutyl, tert-butyl, C5-C20 alkyl, and one, but not both, of the A moieties is benzyl, and combinations thereof.

Preferably, the macropolycyclic ligand is of the formula: 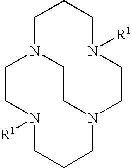
wherein “R¹” is independently selected from H, and linear or branched, substituted or unsubstituted C1-C20 alkyl, alkylaryl, alkenyl or alkynyl; and all nitrogen atoms in the macropolycyclic rings are coordinated with the transition metal.

Of the macropolycyclic ligands 5,12-dimethyl-1,5,8,12-tetraaza-bicyclo[6.6.2]hexadecane is preferred. This ligand is most preferred as its manganese complex [Mn(Bcyclam)Cl₂] and may be synthesised according to WO9839098.

The transition metal complex preferably is of the general formula (AI):
[MₐLₖXₙ]Yₘ
in which:

M represents a metal selected from Mn(II)-(III)-(IV)-(V), Cu(I)-(II)-(III), Fe(II)-(III)-(IV)-(V), Co(I)-(II)-(III), Ti(II)-(III)-(IV), V(II)-(III)-(IV)-(V), Mo(II)-(III)-(IV)-(V)-(VI) and W(IV)-(V)-(VI), preferably from Fe(II)-(III)-(IV)-(V);

L represents the ligand, preferably N,N-bis(pyridin-2-yl-methyl)-1,1-bis(pyridin-2-yl)-1-aminoethane, or its protonated or deprotonated analogue;

X represents a coordinating species selected from any mono, bi or tri charged anions and any neutral molecules able to coordinate the metal in a mono, bi or tridentate manner;

Y represents any non-coordinated counter ion;

a represents an integer from 1 to 10;

k represents an integer from 1 to 10;

n represents zero or an integer from 1 to 10;

m represents zero or an integer from 1 to 20.

pH Jump Composition

The present invention is used as a liquid format where the pH of the commercial product is substantially different to that in use.

Sorbitol/borate compositions are known from EP 381 262. In a concentrated solution the borate is completed with the vicinal diol of the sorbitol; upon dilution of the sorbitol/borate composition the borate is liberated from its interaction with the sorbitol resulting in a pH jump. Other pH Jump formulations are disclosed in U.S. Pat. No. 6,509,308 and U.S. Pat. No. 5,484,555.

Balance Carriers and Adjunct Ingredients

These are generally surfactants, builders, foam agents, anti-foam agents, solvents, and enzymes. The use and amounts of these components are such that the bleaching composition performs depending upon economics, environmental factors and use of the bleaching composition.

The air bleach catalyst may be used in a detergent composition specifically suited for stain bleaching purposes, and this constitutes a second aspect of the invention. To that extent, the composition comprises a surfactant and optionally other conventional detergent ingredients. The invention in its second aspect provides an enzymatic detergent composition which comprises from 0.1-50% by weight, based on the total detergent composition, of one or more surfactants. This surfactant system may in turn comprise 0-95% by weight of one or more anionic surfactants and 5 to 100% by weight of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2%.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates and sodium C₁₂-C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆-C₁₈ primary alcohol sulphate together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

One skilled in the art will appreciate that some adventitious peroxyl species may be in the composition nevertheless it is most preferred that the bleaching composition of the present invention has less that 1%, preferably less than 0.1%, most preferably less than 0.01%, of a peroxyl species present. These adventitious peroxyl are predominantly alkyl hydroperoxides formed by autoxidation of the surfactants.

The composition may contain additional enzymes as found in WO 01/00768 A1 page 15, line 25 to page 19, line 29, the contents of which are herein incorporated by reference. Builders, polymers and other enzymes as optional ingredients may also be present as found in WO0060045.

Suitable detergency builders as optional ingredients may also be present as found in WO0034427.

In the context of the present invention, bleaching should be understood as relating generally to the decolourisation of stains or of other materials attached to or associated with a substrate. However, it is envisaged that the present invention can be applied where a requirement is the removal and/or neutralisation by an oxidative bleaching reaction of malodours or other undesirable components attached to or otherwise associated with a substrate. Furthermore, in the context of the present invention bleaching is to be understood as being restricted to any bleaching mechanism or process that does not require the presence of light or activation by light.

The present invention extends to both isotropic and complex liquid compositions and formulations a brief discussion of which follows. Some isotropic formulations are termed ‘micro-emulsion’ liquids that are clear and thermodynamically stable over a specified temperature range. The ‘micro-emulsion’ formulation may be water in oil, or oil in water emulsions. Some liquid formulations are macro-emulsions that are not clear and isotropic. Emulsions are considered meta-stable. Concentrated, clear compositions containing fabric softening actives have been disclosed in WO 98/08924 and WO 98/4799, both Procter & Gamble. Such compositions comprise bio-degradable fabric conditioners.

However, both disclose compositions comprising water miscible solvents that do not form water-in-oil micro-emulsions. Clear fabric conditioning compositions have also been disclosed in EP 730023 (Colgate Palmolive), WO 96/19552 (Colgate Palmolive), WO 96/33800 (Witco Co.), WO 97/03170 (Procter & Gamble), WO 97/03172 (Procter & Gamble), WO 97/03169 (Procter & Gamble), U.S. Pat. No. 5,492,636 (Quest Int.) and U.S. Pat. No. 5,427,697 (Procter & Gamble). Liquid formulations of the present invention may contain for example; monoethoxy quats; AQAs and bis-AQAs; cationic amides; cationic esters; amino/diamino quats; glucamide; amine oxides; ethoxylated polyethyleneimines; enhancement polymers of the form linear amine based polymers, e.g. bis-hexamethylenetriamine; polyamines e.g. TETA, TEPA or PEI polymers.

It is preferred that the liquid bleaching composition does not contain a pH dependent chromophore, indicator, e.g., phenolphthalein. In addition, it is preferred that the liquid bleaching composition does not contain a pH dependent fluorescent indicator. In both the above cases such should not be present such that a perceptible change is observed to the human eye.

The liquid may be contained within a sachet as found in WO02/068577. The sachet is a container within the context of the present invention.

The liquid composition preferably also contains one or more antioxidants as described in WO02/072747 and WO02072746.

The following is a example of a concentrated liquid formulation that the present invention may be incorporated into by adding the catalyst together with the selected stable perfume components. The commercial liquid formulation has a pH of 7.

| | |
|---|---|
| Sodium citrate: | 3.2% |
| Polypropylene glycol: | 4.75% |
| LAS-acid: | 5.6% |
| NI 25 9 EO: | 6.6% |
| LES (anionic surfactant): | 10.5% |
| Borax: | 2.30% |
| Sorbitol: | 3.35% |
| Alcosperce 725: | 0.30% |
| Coconut fatty acid: | 0.73% |
| Monoethanolamine: | 0.20% |
| Fluorescer: | 0.125% |
| Enzymes | — |
| Perfume/dye | — |

Experimental

The following catalyst was used in the experiments 9,9-dihydroxy-2,4-di-(2-pyridyl)-3-methyl-7-(pyridin-2-ylmethyl)-3,7-diaza-bicyclo[3.3.1]nonane-1,5-dicarboxylate Iron (II) dichloride was prepared as described by Heidi Borzel, Peter Comba, Karl, S. Hagen, Yaroslaw D. Lampeka, Achim Lienke, Gerald Linti, Michael Merz, Hans Pritzkow, Lyudmyla V. Tsymbal in Inorganica Chimica Acta 337 (2002) 407-419. WO0248301 provides synthetic details of similar compounds. This catalyst was incorporated at a concentration of 0.03% wt/wt in concentrated liquid composition A containing.

Liquid A: 6% LAS, 6% sLES 3 EO, 6% Nonionic 7 EO, 0.016% Proxel GXL, 3.35% sorbitol, 2.30% Borax. 10 H2O, 4.75% MPG, and sufficient NaOH to bring the pH to 7.

Method of Determining Catalyst Stability

The residue bleaching activity of bleaching compositions were determined at 40° C. in a H2O2 containing NaH2PO4.H2O pH7 buffer and Acid Blue 45 (CAS No. 2861-02-1) as substrate using the following protocol.

Samples of 70 mg liquid were diluted in 10.00 ml MilliQ water. We added 45 μl of this solution to an assay of 230 μL containing 20 mM H2O2, 75 μM Acid blue 45 and 54 mM NaH2PO4.H2O pH7 buffer.

The changes in absorbance at 600 nm were measured for 5 min at 40° C. using a spectrophotometer. The absolute changes in absorbance were correlated to activities obtained with freshly prepared calibration samples. The measured activities were expressed as μMol/l/. The residual amount is the activity measured on t=0 divided by the activity after storage and expressed in percentages.

TABLE 1
The bleaching catalysts stability expressed as residual amount
(%) as function of the pH during storage storage at 37° C..

| pH | 1 wk | 2 wks | 3 wks | 4 wks |
|---|---|---|---|---|
| 6 | 96 | 82 | 80 | 78 |
| 6.25 | 97 | 84 | 76 | 80 |
| 6.5 | 99 | 91 | 82 | 84 |
| 6.71 | 100 | 88 | 83 | 80 |
| 7 | 100 | 79 | 71 | 70 |
| 7.25 | 85 | 67 | 56 | 54 |
| 7.52 | 84 | 62 | 54 | 45 |
| 7.75 | 68 | 43 | 38 | 32 |
| 8 | 62 | 39 | 33 | 25 |

The results in Table 1 clearly show a storage advantage in maintaining the concentrated liquid bleaching composition at a pH at 7 or below. Upon dilution of the concentrated liquid bleaching composition the pH of the solution changes to alkali which activates the bleaching composition.

1. A liquid bleaching composition having a pH between 6 and 7 comprising:
(a) an organic substance which forms a complex with a transition metal for bleaching a substrate with atmospheric oxygen, the bleaching composition upon addition to an aqueous medium providing an aqueous bleaching medium substantially devoid of a peroxygen bleach or a peroxy-based or peroxyl-generating bleach system, wherein the organic substance is selected from the group consisting of: 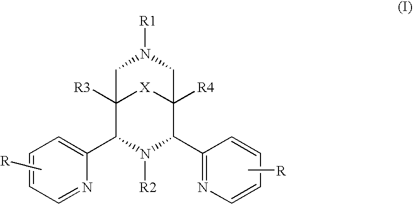
wherein each R is independently selected from: hydrogen, F, Cl, Br, hydroxyl, C1-C4-alkylO—, —NH—CO—H, —NH—CO-C1-C4-alkyl, —NH2, —NH—C1-C4-alkyl, and C1-C4-alkyl;
R1 and R2 are independently selected from:
C1-C4-alkyl,
C6-C10-aryl, and,
a group containing a heteroatom capable of coordinating to a transition metal, wherein at least one of R1 and R2 is the group containing the heteroatom;
R3 and R4 are independently selected from hydrogen, C1-C8 alkyl, C1-C8-alkyl-O—C1-C8-alkyl, C1-C8-alkyl-O—C6-C10-aryl, C6-C10-aryl, C1-C8-hydroxyalkyl, and —(CH2)nC(O)OR5
wherein R5 is independently selected from: hydrogen, C1-C4-alkyl, n is from 0 to 4, and mixtures thereof; and,
X is selected from C═O, —[C(R6)2]y- wherein Y is from 0 to 3 each R6 is independently selected from hydrogen, hydroxyl, C1-C4-alkoxy and C1-C4-alkyl, and
An organic substance of formula: 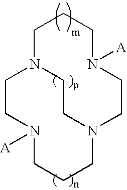
wherein m and n are 0 or integers from 1 to 2, p is an integer from 1 to 6, preferably m and n are both 0 or both 1 (preferably both 1), or m is 0 and n is at least 1; and p is 1; and A is a nonhydrogen moiety preferably having no aromatic content; more particularly each A can vary independently and is preferably selected from methyl, ethyl, propyl, isopropyl, butyl, isobutyl, tert-butyl, C5-C20 alkyl, and one, but not both, of the A moieties is benzyl, and combinations thereof; and
(b) a pH changing means; and,
(c) the balance carriers and adjunct ingredients to 100 wt/wt % of the total bleaching composition,
wherein upon dilution of the liquid bleaching composition with water the pH of the liquid bleaching composition enters the range pH 7.5 to pH 9.0.

2. A liquid bleaching composition according to claim 1, wherein upon dilution of the liquid bleaching composition with water the pH of the liquid bleaching composition reaches at least pH 8.0.

3. A liquid bleaching composition according to claim 1, wherein the pH changing means is provided by a borax sorbitol pH jump composition.

4. A liquid bleaching composition according to claim 3, wherein the liquid bleaching composition comprises at least 2% wt/wt of sorbitol and at least 1 wt/wt % borax.

5. A liquid bleaching composition according to claim 1, wherein the organic substance 5,12-dimethyl-1,5,8,12-tetraaza-bicyclo[6.6.2]hexadecane.

6. A method of bleaching a textile comprising the steps of:
(i) diluting from 0.5 to 20 g of a concentrated liquid bleaching composition as defined in claim 1, with 1 litre of water, the concentrated liquid bleaching composition having a pH in the range 6 to 7, the liquid bleaching comprising an organic substance which forms a complex with a transition metal for bleaching a substrate with atmospheric oxygen, the bleaching composition upon addition to an aqueous medium providing an aqueous bleaching medium substantially devoid of a peroxygen bleach or a peroxy-based or peroxyl-generating bleach, the dilution providing an aqueous liquid bleaching composition having a pH in the range from 7.5 to pH 9.0;
(ii) treating a textile with the aqueous liquid bleaching composition; and,
(iii) rinsing the textile with water; and,
(iv) drying the textile.
